(19) United States
(12) Patent Application Publication
(10) Pub. No.: US 2005/0076301 A1
(43) Pub. Date: Apr. 7, 2005

(54) Apparatus, system, and method for managing fitness data

(76) Inventor: Tevya A. Weinthal, Carlsbad, CA (US)

Correspondence Address: CHARLES D. GAVRILOVICH, JR.,;A PROFESSIONAL CORPORATION, 985 PASEO LA CRESTA, SUITE A, CHULA VISTA, CA, 91910-6729, US

(21) Appl. No.: 10/676,756

(22) Filed: Oct. 1, 2003

(51) Int. Cl. G06F 17/00

(52) U.S. Cl. 715/541

(57) ABSTRACT

An apparatus, system and method manage fitness data by capturing, storing and displaying fitness information based on hand-marked fitness data. A fitness participant creates a fitness data record by entering characters, symbols, or other marks into a data record form. A digital image captured by a scanning device is analyzed by an automated data collection engine to convert the fitness data to electronic fitness data. A server generates fitness information based on the electronic fitness data and transmits a fitness information message to a user terminal through a communication network. The user information is displayed on the user terminal in accordance with the fitness information message.

### BACKGROUND OF THE INVENTION

The invention relates in general to data processing and more specifically to an apparatus, systems and method for managing fitness data.

Management of fitness data is performed for a variety of reasons. Many fitness participants who engage in fitness activities such as weight training and aerobic activities often track fitness data such as times, dates, the amount of weight, the number of repetitions, and the number of sets for various exercises, sports, or other activities. One method of recording the fitness data includes entering the fitness data using a writing instrument into a logbook or onto other types of paper media. The fitness data is later accessed by the fitness participant to monitor changes in any of the recorded categories. In order to access the fitness data and draw any conclusions regarding progress, the fitness participant must at least access two records. Often, however, several records must be evaluated and compared in order to develop accurate and useful information. Time consuming and inconvenient procedures are required each time the fitness data is evaluated. One attempted solution to the inefficiency problem includes manually typing the fitness data into a computer and retaining the data as an electronic file. The procedure is still time consuming and inconvenient although the fitness data may be more easily organized and accessed once the data is in the electronic format. Other attempted solutions include entering the fitness data directly into an electronic device such as a personal digital assistant at the time the activities or exercise is performed. This conventional technique, however, is limited in that fitness participants must have a portable electronic device and must be willing to bring it to the fitness facility where the activities and exercises will be performed. There is risk that the portable electronic device will be lost or stolen. Due to the cost of such devices, many fitness participants prefer not to manage fitness data in this manner.

Accordingly, there is need for an apparatus, system and method for managing fitness data that is efficient, inexpensive, and convenient.

### BRIEF DESCRIPTION OF THE DRAWINGS

FIG. 1 is a block diagram of a fitness data management system in accordance with the exemplary embodiment of the invention.

FIG. 2 is a block diagram of a top view of a data record in accordance with the exemplary embodiment of the invention.

FIG. 3 is a block diagram of a data processor in accordance with the exemplary embodiment of the invention.

FIG. 4 is an illustration of an exemplary data record created from a customized data record form.

FIG. 5 is an illustration of an exemplary data record created from a generic data record form.

FIG. 6 is a block diagram of a user interface displaying fitness information in accordance with the exemplary embodiment of the invention.

FIG. 7 is a flow chart of method of managing fitness data in accordance with the exemplary embodiment of the invention.

FIG. 8 is a flow chart of an exemplary method of converting hand-marked fitness data into electronic fitness data.

FIG. 9 is a flow chart of an exemplary method of processing electronic fitness data.

### DETAILED DESCRIPTION OF THE PREFERRED EMBODIMENTS

An apparatus, system, and method provide efficient, inexpensive and convenient management of fitness data. In accordance with the exemplary embodiment of the invention, fitness data is extracted from a data record and stored as electronic fitness data in a format that can be manipulated by a computer. The electronic fitness data is accessible at a user terminal through a packet switched network such as the Internet. In the exemplary embodiment, a server computer stores and organizes the electronic fitness data as well as providing fitness information derived from the electronic fitness data. The fitness information may be displayed in any of several reporting formats including graphical, tabular, or textual formats. In some circumstances, additional information may be displayed with the fitness information to the user. Such information may include text, images or hypertext links for advertisements, articles, glossaries, discussion boards, message boards, statistical data, schedules, and directories related generally to fitness and health management.

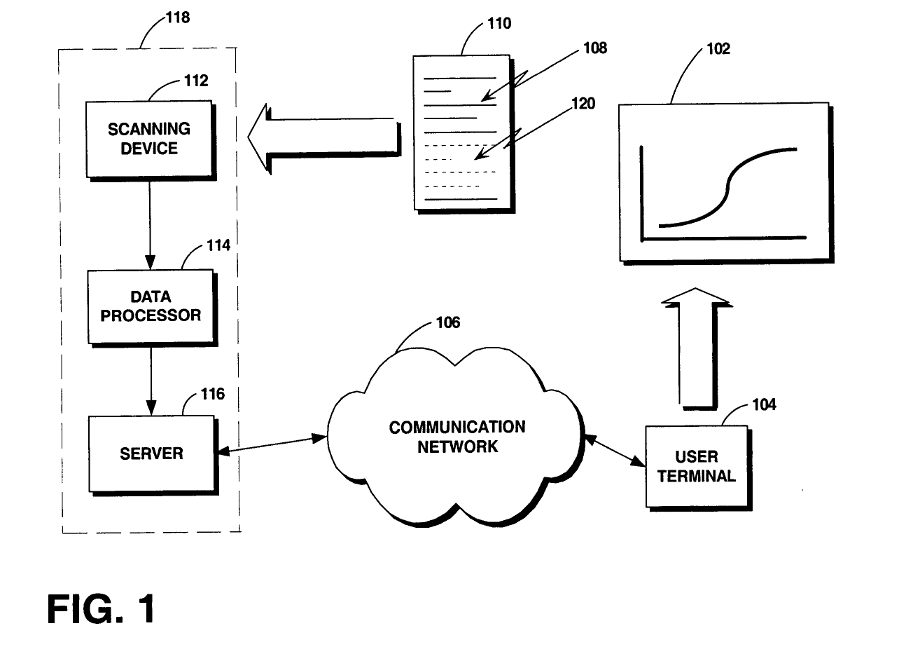

FIG. 1 is a block diagram of a fitness data management system 100 in accordance with the exemplary embodiment of the invention. A fitness participant (user) views fitness information 102 through a user terminal 104 connected to a packet switched network 104 where the fitness information 102 is derived at least from hand-marked fitness data 120 fitness data 108 manually entered into a fitness record 110. In addition to the hand-marked fitness data 120, the fitness data 108 contained in the data record 110 may include printed fitness data. A scanning device 112 forwards a digital image of the fitness record 110 to a data processor 114. The data processor 114 converts the fitness data 108 into electronic fitness data that includes the fitness data 108 in a format that can be read and manipulated by a computer or processor. After the server 116 reads and stores the electronic fitness data in a data base (not shown), the server 116 uses the fitness data 108 in the electronic data file representing the electronic fitness data to generate fitness information messages that can be transmitted to the user terminal 104. The fitness information messages are deciphered by the user terminal 104 and displayed to the user as fitness information 102.

The scanning device 112 optically scans the fitness record 110 that includes the fitness data 108 to convert the image on the fitness record 110 into a digital image. The fitness record 110 is any type of record that includes at least some hand-marked fitness data 120. In the exemplary embodiment, the fitness record 110 is a paper document that includes printed data, handwritten fitness data and hand-marked “bubbles”. Hand-marked fitness data 120, therefore, includes any combination of markings and alphanumeric characters. Examples of markings include filled-in circles, checks, “X”s, or symbols. The printed fitness data defines a blank fitness form containing headings and blank fields. The fitness participant completes the data record form by entering marks, words, or numbers into the blank fields using a writing instrument such as pen or pencil. As discussed in further detail below, the data record form may include any combination of bubbles such as ovals or circles that can be filled in, blank boxes, lines, or other open areas on the paper document. In the exemplary embodiment, the fitness participant (user) writes numbers into the fields to record the hand-marked portion (120) of the fitness data 108. The fitness data 108 includes data related to fitness such as data related to time, date, weight, duration, number of repetitions, number of sets for an exercise, weight training, aerobic activity, competitions, and other fitness activities. The fitness data 108 may include a variety of parameters, values or information. Examples of other fitness data 108 includes the ambient temperature, the humidity, the type of exercise machinery, the location, the type and quantity of dietary supplements, the diet of the fitness participant, the number of hours of sleep of the fitness participant, and the availability and identity of other parties during fitness activity (e.g. personal trainer, workout partner). Accordingly, fitness data 108 may includes data related to activities, to environmental conditions or to physiological conditions of the fitness participant.

Although the blank data record forms may be generated in a variety of ways, the blank forms are printed based on user preferences provided to the server 116 in the exemplary embodiment. The user accesses the server 116 by “logging-in” to the server 116 through a user terminal 104 and selects fitness activities for which fitness data 108 will be recorded. The server 116 presents the user with a user interface such as a web page including optional fitness activities and instructions for creating the blank data record form. After the user makes the selections and the customized blank form is created, the user may print the form directly on an attached printer (not shown), may store an electronic version of the blank form, or may have the blank form printed on a remote printer. In some circumstances the blank data record form may be mailed to the user from the remote printer using a postal or courier service.

The scanning device 112 is any type of optical scanner, facsimile machine or other device capable of converting the image of the data record 110 into a digital image. The digital image may be captured and stored in a variety of formats based on the particular implementation of the fitness data manager 118. Examples of some of the numerous suitable formats include the TIFF (Tagged Image File Format), BMP (Bitmapped format), GIF (Graphics Interchange Format), JPEG (Joint Photographic Experts Group), PDF (Portable Document Format) and the PCX (Graphics File Format). The particular selection of the format at least partly depends on the type of transmission, the amount of loss that can be tolerated during compression, processor speeds and other factors recognized by those skilled in the art. The digital image is forwarded to the data processor 114 using a suitable transmission technique. Where the scanning device 112 is a facsimile machine, the digital image is conveyed using a universal protocol such as the Group 3 standard developed by the CCITT (Comité Consultatif International Téléphonique et Télégraphique). The data processor 114 may include or may be connected to a FAX server where the digital image is transmitted using a FAX machine. Where the scanning device 112 is a scanner connected to a processor coupled to the Internet, the digital image is transmitted as a file in accordance with Internet Protocol (IP) techniques such as HTTP (Hyper Text Transfer Protocol) or FTP (File Transfer Protocol) techniques. Other standard and proprietary protocols may be used to transmit the digital image of the fitness record to the data processor. Other examples include using Ethernet or token ring network protocols where the scanning device 112 and data processor 114 are connected using a computer network. Further, depending on the particular distribution of the elements of the fitness data manager 118, multiple protocols and formats may be used between various devices and equipment.

The data processor 114 converts the digital image into electronic fitness data that can be manipulated by a computer or other processor. Therefore, as used herein, the term ‘electronic fitness data’ applies to an electronic file, set of files, or other data representing the fitness data 108 (or the fitness data record 110) in a format that allows a computer or processor to recognize the fitness data 108 values and parameters represented by the electronic fitness data corresponding to the fitness data 108. In the exemplary embodiment, the electronic fitness data is transmitted to a server in an XML (Extensible Markup Language) format. The electronic ftines data, however, may be stored, manipulated and transmitted using other conventional, standard, or proprietary formats. Examples of other suitable formats include formats using SGML (Standard Generalized Markup Language) or HTML (Hypertext Markup Language). In the exemplary embodiment, the data processor 114 is implemented with software code running on a processor that may include any number or combination of computers, processors, microprocessors, processor arrangements or personal computers. The data processor 114, therefore, may be implemented in a single computer or processor or may be distributed over several processors and computers. The data processor 114 may be co-located within the scanning device 112 or may be remotely located and connected to the scanning device 112 through a communication network or system. As discussed below in further detail, the data processor 114 is implemented as an automated data collection engine and a data verification engine in the exemplary embodiment. The data verification engine includes some analysis by a technician and is not necessarily performed at the same location as the automated collection process in the exemplary embodiment.

After receiving the electronic data records 110, the server 116 stores the electronic data records 110 in memory (not shown) such as a data base. The server 116 is any type of computer server having sufficient processing power and memory to perform the functions described herein and may be any combination of processors, computer, parallel processors, and microprocessors. An example of a suitable server is a server computer having dual 2.4 GHZ Pentium processors running a Microsoft Windows sever operating system. Software code running on the 116 server manages, stores, and manipulates the electronic fitness information by executing processes such as a CGI (Common Gateway Interface) process, an API (Application Program Interface) process, a subroutine, a Java servlet or other type of executable software code. In response to requests received through the communication network 106, the server 116 “pushes” web pages containing fitness information 102 to the designated IP (Internet Protocol) address as defined by the request.

The scanning device 112, data processor 114, and server 116 form the fitness data manager 118. Although the fitness data manager 118 is geographically distributed and includes more than one hardware device in the exemplary embodiment, the fitness data manager 118 may be implemented in any of several configurations. For example, the fitness data manager 118 may be implemented as a single device in some circumstances. The scanning device 112 may be integrated with a computer that performs the functions of the data processor 114 and the server 116. Further, the computer may be directly connected to the user terminal 104. Such a configuration allows the user to scan the fitness record 110, view fitness information 102 and track data without access to a communication network or other resources. Accordingly, the fitness data manager 118 may be implemented in a computer system including a scanner, a display and a personal computer running software that performs the functions of the data processor 114 and the data manipulation functions performed in the server 116. In another exemplary implementation, the data processor 114 and the server 116 may be integrated in a single computer or processor. Further, some of the functions of the data processor 114 may be performed at a processor co-located with the scanning device 112 while the remaining data processor 114 functions are performed in the server 116.

In the exemplary embodiment, the user logs onto the server 116 by accessing the appropriate login web page through the user terminal 104 connected through a packet switched network in the communication network 106. The communication network 106 may include any combination or number of communication systems, hardware devices, and processes. The communication network 106 includes at least a packet switched network such as the Internet in the exemplary embodiment. Examples of other types of packet switched networks include Intranets and virtual private networks (VPNs). The user terminal 104 can be any type of device capable of connecting to the server 116 through the communication network 106. In the exemplary embodiment, the user terminal 104 is a PC (personal computer) connected to the Internet and running Web browser software such as such as those available from Netscape and Microsoft. The user terminal 104 may be connected using any of several known techniques. For example, the user terminal 104 may be connected through a modem to an ISP (Internet Service Provider). The connection to the user terminal 104 may include any combination or arrangement of wires, twisted pair wiring, coaxial cable, radio frequency (RF), microwave, or other wireless or wired connections. After accessing the login page, the user enters identification information. Although any level and combination of authentication and authorization procedures may be used to allow and deny access to the server 116, a user identification (user ID) and password uniquely identifies each user in the exemplary embodiment. A successful login procedure allows the user to access the user's account. Although any number of features and information can be provided to the user, the user has access to on-line ‘chat rooms’, message boards, links, calculators, on-line stores, announcements, schedules, articles, and advertising related to fitness, as well as the fitness information 102 in the exemplary embodiment.

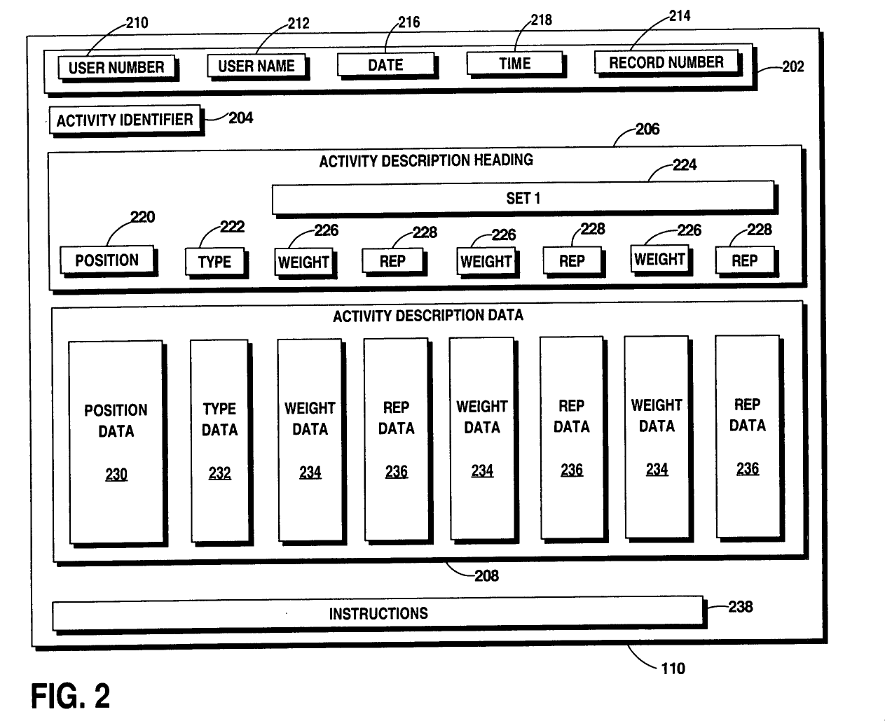

FIG. 2 is a block diagram of a fitness record 110 in accordance with the exemplary embodiment of the invention. The fitness record 100 may include any number and any combination of items such as printed alphanumeric characters, written alphanumeric characters, bar codes, bubbles, boxes, lines, logos and graphics. Although in some circumstances all of the items in the fitness record 110 may be fitness data 108, some of the data may include identification and documentation data. In the exemplary embodiment, the fitness record 110 includes at least identification data 202, an activity identifier 204, an activity description heading 206 and activity description data 208. Other combinations of information and data may be used in other circumstances.

The identification data 202 includes a combination of printed alphanumeric characters, printed symbols, graphics, written alphanumeric characters, and other markings that uniquely identify the data record 110. In the exemplary embodiment, the identification data 202 includes a user number 210, a user name 212, a record number 214, as well as the date 216 and time 218. Some or all of the identification data 202 may be machine printed on the data record 110 where a customized data record form is used. Where a generic data record form is used, the identification data 202 may be handwritten or otherwise entered by the fitness participant. An example of another suitable method of entering the identification data 202 includes applying a self-adhesive label including printed letters, numbers or barcode that provides identification information.

The user number 210 uniquely identifies the fitness participant that is entering hand-marked fitness data 120 onto the data record form. The user number 210 provides an efficient and accurate way of tracking a particular fitness participant and may be printed on a customized data record form or may be entered by the user in a generic data record form as explained above.

The user name 212 includes text identifying the fitness participant (user) that is entering the fitness data 108. In some circumstances, the user name 212 is printed on a customized data record form. Where a generic form is used, the fitness participant enters their name into a designated field. The record number 214 uniquely identifies the particular data record 110 and is machine printed on the data record form in the exemplary embodiment. The record number 214 may be entered using other techniques in some situations, however. In some circumstances, one or more of the items in the identification data 202 may be omitted. For example, the user name 212 may be omitted in some situations where a valid user number 210 is used. Further, in a customized data record form, the user name 212, and the user number 210 may be omitted and the record number 214 may provide sufficient information to identify the fitness participant (user).

The activity identifier 204 identifies the activity for which the fitness participant enters the hand-marked fitness data 108. The activity identifier 204 includes either handwritten or printed text of the name of the fitness activity in the exemplary embodiment. Examples of fitness names include “bench press”, “butterfly”, “military press”, “leg extension”, “bicep curl”, “pushup”, “pull-up”, “freestyle”, “breath stroke”, “back stroke”, “run”, “walk”, “stair-climber machine”, “treadmill”, “basket ball”, “volley ball” and “soccer”. The fitness identifier 204, however, may be a number or other marking such as a bar code and may identify any of numerous activities, sports, or exercises.

The activity description heading 206 indicates to the fitness participant the appropriate locations, fields, boxes, or bubbles for entering the hand-marked fitness data 108. In the exemplary embodiment, the activity description heading 206 includes a position heading 220, a type heading 222, a set heading 224, and a weight heading 226 and repetition heading (rep) 228 for each set indicated in the set heading 224. The position heading 220 identifies the area where the position data 230 of the activity description data should be entered. In the exemplary embodiment, the position heading 220 includes a text indicating FLAT, DECLINE and INCLINE positions directly above the position data 230 which includes a filled-in bubble designating the appropriate position. The type heading 222 indicates the appropriate location for entering the type of exercise equipment used and includes text identifying barbell, dumbbell and machine equipment in the exemplary embodiment.

As discussed further below, the type data 232 entered directly below the type heading 222 includes a filled-in bubble in the column indicating the appropriate equipment type in the exemplary embodiment. The set heading 224 includes text identifying the location for entering the fitness data 108 pertaining to the particular exercise set. Any number of sets can be indicated. In the exemplary embodiment six sets are used (three sets are not shown in FIG. 2).

The weight heading 226 and the repetition heading 228 indicate the location for entering the weight data 234, and repetition data 236 for each set. The weight data 234 and the repetition data 236 is entered by writing numerals into boxes in the exemplary embodiment. Other methods of entering fitness data 108 may be used in some circumstances.

The exemplary data record 110 also includes an instructions section 238 that provides instructions for completing and submitting the data record form. The instructions include a telephone number for transmitting the completed data record 110 via a facsimile machine in the exemplary embodiment.

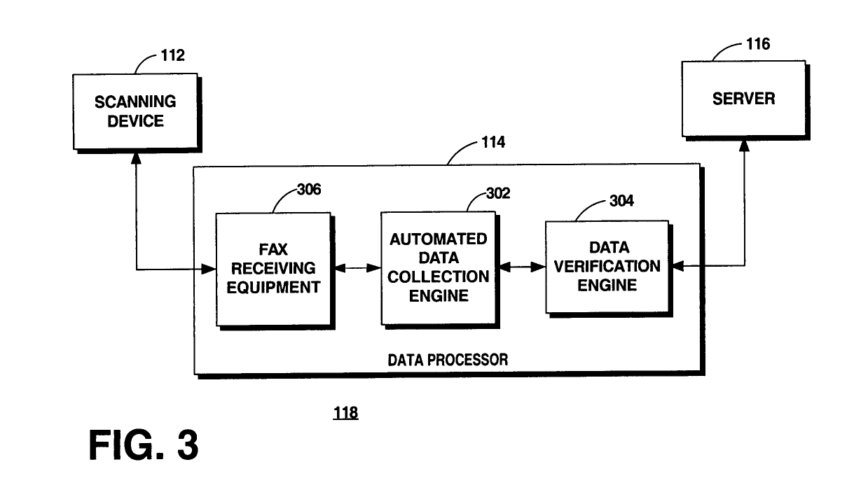

FIG. 3 is a block diagram of an exemplary fitness data manger 118. Although the data processor 114 may be implemented using any of several devices, hardware, software and techniques, the data processor 114 includes an automated collection engine 302 and a data verification engine 304 and FAX receiving equipment 306 in the exemplary embodiment. The automated data collection engine 302 includes software code running on a processor or computer that analyzes the digital image produced by the scanning device 112. In the exemplary embodiment, the automated data collection engine 302 includes software code performing data collection in accordance with OCR (Optical Character Recognition, ICR (Intelligent Character Recognition) and OMR (Optical Mark Recognition) techniques. In some circumstances “key from image” technologies may be used. Also, the automated collection engine 302 may be implemented within the server or the scanning device 112 in some circumstances. In accordance with known techniques, the automated data collection engine 302 deciphers the fitness data 108 to form an electronic data file (electronic fitness data) that represents the data. Each character, symbol, and other marking conveying fitness data 108 is evaluated to determine the value or information that is represents. The resulting electronic data file can be read, recorded or otherwise manipulated by a computer or processor.

The data verification engine 304 provides additional processing to maximize the accuracy of the conversion to electronic data performed by the automated data collection engine 302. In the exemplary embodiment, a technician compares the original digital image to an image based on the electronic data file to identify any inconsistencies or errors. Therefore, the accuracy of the data extracted using ICR, OCR, or OMR is verified. The technician modifies the electronic data file to correct for any errors before the electronic data file is forwarded to the server 116. The data verification engine 304 includes a computer or other processor that is connected to the automated data collection engine 302. The technician reviews the electronic fitness data, corrects any errors, and transmits the corrected electronic fitness data to the server using XML techniques. Examples of other suitable techniques for transferring the data to the server 116 include transmitting ASCII (American Standard Code for Information Interchange) or CSV (comma-separated values) files and exchanging data through an ODBC (Open Data Base Connectivity) interface.

In the exemplary embodiment, the scanning device 112 is a facsimile (FAX) machine connected to the automated data collection engine 302 through FAX receiving equipment 306. The FAX receiving equipment 306 is connected though a PSTN (Public Switched Telephone Network) to the facsimile (FAX) machine (112). The fitness participant or other individual, such as fitness facility representative, uses the FAX machine (112) as the scanning device 112 to transmit the digital image of the data record 110 to the FAX receiving equipment 306 connected to the automated collection engine 302. Based on an entered FAX number, the FAX machine establishes a communication link and transmits the digital images to the FAX receiving equipment 306 in accordance with the Group 3 standard developed by the CCITT. In the exemplary embodiment, the FAX receiving equipment is a FAX server connected to the automated data collection engine 302 through a communication network. After receiving the facsimiles, the FAX server emails the digital images to the automated data collection engine 302. Other techniques for transferring the digital images to the automated data collection engine 302 include transmitting the digital image files through a LAN (Local Area Network) and placing the images in a common directory for retrieval by the automated data collection engine 302. In some circumstances the FAX receiving equipment 306 may be co-located with the automated data collection engine 302.

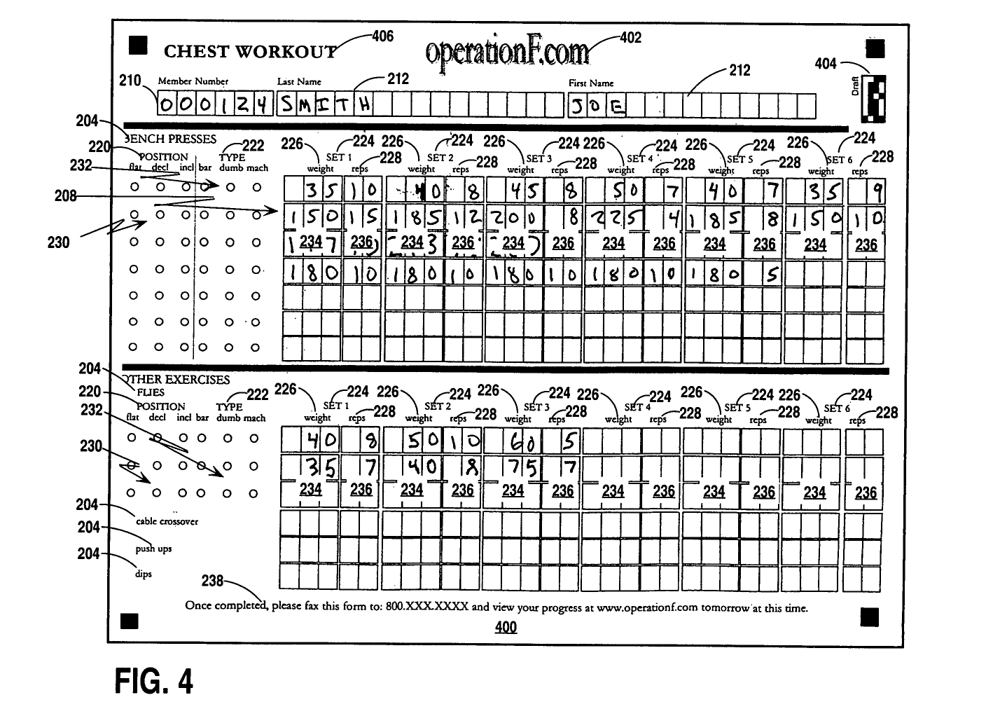

FIG. 4 is an illustration of an exemplary customized data record 400. A data record form is used by the fitness participant to enter hand-marked fitness data 120 pertaining to a chest workout to create the exemplary customized fitness data record 400. The various activity identifiers 204, activity description headings 206 and activity description data 208 fields relate to activities designed to work upper body muscles such as pectoral, bicep, tricep, and deltoid muscle groups. The activity identifiers 204 include “BENCH PRESS”, “FLIES”, “CABLE CROSSOVERS”, “PUSH-UPS”, and “DIPS” designations. The corresponding activity description data 208 fields include bubbles and boxes where the bubbles are marked by the user to indicate equipment position and type and where numerals are handwritten in the boxes to indicate fitness data 108 such as weight and repetitions. The fitness participant creates a data record 400 (110) by hand-marking the data record form using a writing instrument. The resulting data record 110, therefore, depends at least in part on the printed information in the data record form. Other graphics can be included in the data record form in some circumstances. The exemplary data record form, for example, includes a logo 402. Further, some character recognition software may utilize a block form identifier 404.

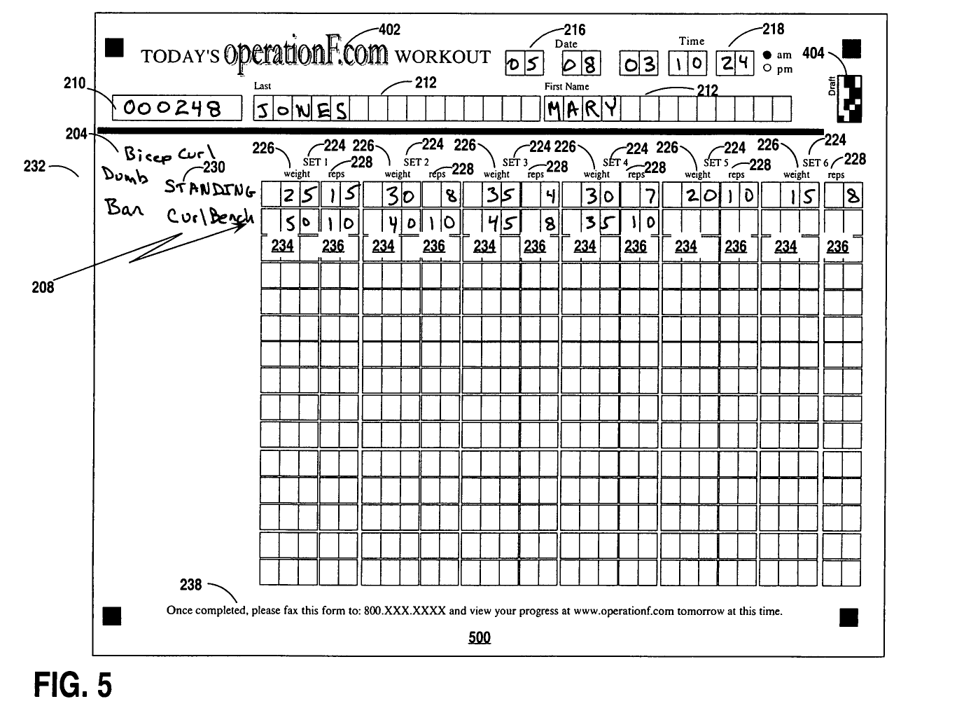

FIG. 5 is an illustration of an exemplary generic data record 500. The generic data record form includes an area for the fitness participant to enter one or more activity identifiers 204 by handwriting the name of the activity next to the appropriate fields in the activity description data 208. The fitness participant creates the generic data record 500 by completing the generic data record form.

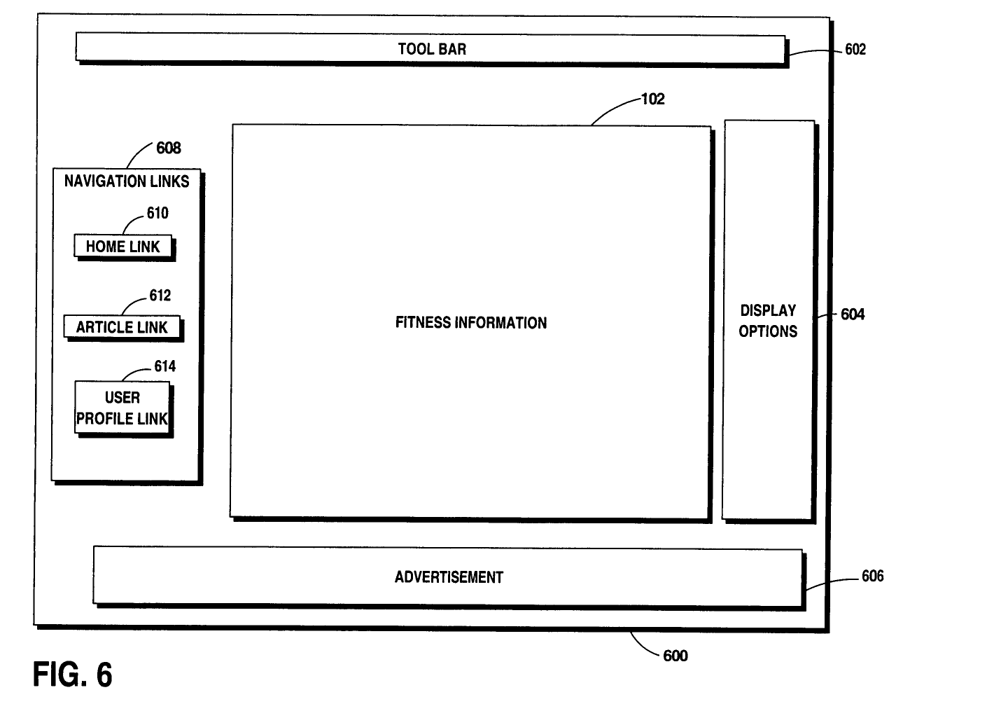

FIG. 6 is a block diagram of an exemplary user interface 600 including fitness information 102. In the exemplary embodiment, web browser software running on the user terminal 104 receives and processes HTML messages to provide the user interface 600 to the fitness participant or other user. The HTML messages result in images, graphs, tables, text, and other graphics to be displayed on a visual display such as a computer monitor. In some circumstances sounds may be presented through speakers based on the HTML messages. The blocks illustrated in FIG. 6 represent interactive and non-interactive images displayed by the web browser software. Each block, therefore, may represent text, graphics, images, hypertext links, buttons, or other features in accordance with known web browser techniques. The blocks as illustrated in FIG. 6 do not necessarily depict relative positions, sizes, or shapes of the items displayed and the visual display of the blocks may include a variety of shapes, sizes, colors and relative positions. Further, additional features may be included and the represented items may be omitted or modified depending on the particular implementation and situation.

The user interface 600 includes at least fitness information 102 which may be in any of several forms or formats. In the exemplary embodiment, the fitness information 102 is displayed in one of three formats based on the user's preference. Display options 604 allow the user to select a line graph format (frequency polygon), a histogram format (bar chart) or a tabular format. Examples of other suitable formats include textual formats, word-processing and spreadsheet formats, audio formats and other graphical formats such as pies charts and Venn diagrams.

The fitness information 102 may depict the raw data entered by the fitness participant or may depict a relationship within the data. The fitness information 102 may illustrate any of numerous relationships such as relationships between the various fitness data 108 values and other fitness data 108 values and relationships of the fitness data 108 values over time. The user selects any of several relationships using the tool bar 602 and, in the exemplary embodiment, may select fitness information 102 illustrating relationships of original and calculated fitness data 108 values over time and the relationships between the various original and calculated fitness data 108 values. Examples of the fitness information 102 include graphs for a particular fitness activity showing total weight over time, average weight over time, peak weight over time, number of sets over time, number or repetitions over time, average weight compared to total number of sets, average weight compared to the total number of repetitions per set, and average weight compared to the total number of repetitions for a workout. Further, the user may select fitness information 102 conveying the correlations between fitness values pertaining to two or more different fitness activities. For example, the fitness information 102 may illustrate the relationship between total weight lifted per day for bicep curls compared to total weight lifted for bench press per day. The user may derive correlations and trends based on the fitness information 102 to improve or further refine a workout regiment to maximize efficiency and results. The fitness information 102 is not necessarily confined to fitness data 108 previously provided by the particular user viewing the fitness information 102 and may include fitness data 108 provided by other users, by external resources, and by the user when accessing the fitness data management system 100. Where fitness information 102 is based on fitness data 108 provided by other users, the fitness information 102 may provide information that allows the user to track progress compared to other users. An example of such fitness information 102 includes the number of workouts per week, the percentage of exercise weight increase per week or the percentage in decrease in body weight over time. External resources such as on-line weather sources may provide fitness data 108 such as relative humidity, temperature or moon cycles for days of interest. The particular fitness information 102 displays, graphs, and illustrations may convey any of numerous relationships and the particular options available to a user will depend on factors such as system resources, system provider preferences and user preferences. Those skilled in the art will recognize the various additional relationships and displays of fitness information 102 based on these teachings and known techniques.

The user interface 600 includes navigation links 608 in the exemplary embodiment. Examples of links that may be included on the user interface 600 include a home link 610, an article link 612, and user profile link 614. The user may access the home page of the fitness data management service provider or other service provider by selecting the home link 610. Pages containing articles or other useful information and statistics are available by selecting the article link 612. Further, when the user selects the user profile link 614, the user is directed to a user profile page where administrative and other user specific preferences may be selected or modified. The user, for example, may change authentication information such as a password using the user profile page.

Further, the user interface 600 may include one or more advertisements 606 in some circumstances. The advertisements 606 presents targeted fitness related advertising to individuals interested in fitness products and services. Advertisements 606 may not be appropriate in all implementations and, where included, may allow the fitness management service provider to derive additional revenue.

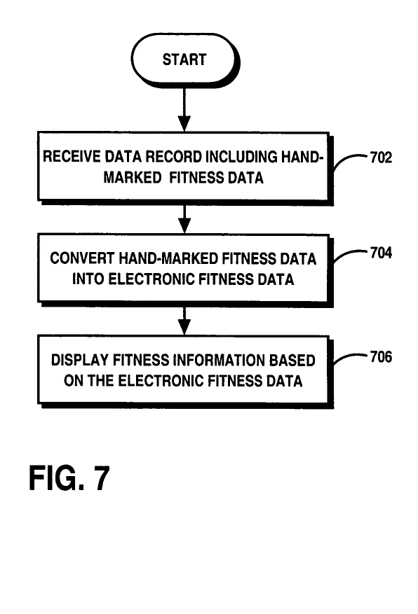

FIG. 7 is a flow chart of a method of fitness data management in accordance with the exemplary embodiment. The method may be performed using any hardware or software within in a single device or in a distributed network or system. In the exemplary embodiment, the method is performed by the fitness data management system 100.

At step 702, a data record 110 including hand-marked fitness data 120 is received. In the exemplary embodiment, the data record 110 including at least hand-marked fitness data 120 is received by the scanning device 112. In some circumstances, the fitness data record 110 may include printed fitness data in addition to the hand-marked fitness data 120.

At step 704, the hand-marked fitness data 120 is converted into electronic fitness data. In the exemplary embodiment, the fitness data manger 118 recognizes hand-marked characters symbols and other marks in addition to printed fitness data.

At step 706, fitness information 102 based on the electronic fitness data is displayed. In the exemplary embodiment, a computer such as a server 116 manipulates and analyzes the fitness data 108 to derive the fitness information 102. The fitness information 102, may include graphs, tables, text, sound, or other multimedia conveying information based at least on the hand-marked fitness data 120. The fitness information 102 is displayed on the user terminal 104.

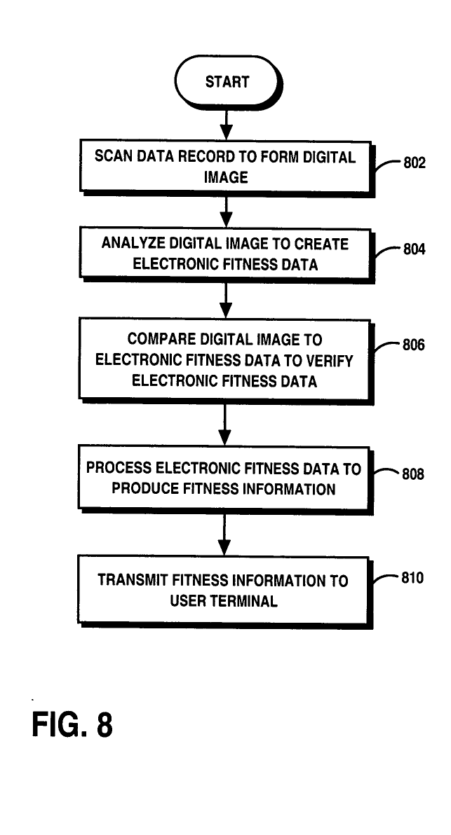

FIG. 8 is a flow chart of an exemplary method of converting hand-marked fitness data 120. The method illustrated in FIG. 8, provides a suitable example of a method of performing step 704 of FIG. 7.

At step 802, the data record 110 is scanned to form a digital image. As discussed above, a scanning device 112 such as an optical scanner or facsimile machine scans the data record 110 and forms a digital image in the exemplary embodiment. The digital image may be in any of several standard or proprietary formats where suitable formats include formats in accordance with TIFF, GIF, PCX, JPEG, BMP, and CCITT formats and standards. The digital image is forwarded to an automated data collection engine in the fitness data manager 118.

The fitness data manager 118 analyzes the digital image to create electronic fitness data at step 804. As described above, the automated data collection engine 302 in the fitness data manager 118 converts the digital image to an electronic file using a method in accordance with known character, image and mark recognition.

At step 806, the digital image is compared to the electronic fitness data to verify the electronic fitness data. In the exemplary embodiment, a technician compares the digital image to an image based on the electronic fitness data to identify any errors. The technician corrects the errors prior to forwarding the electronic fitness data to the server 116.

At step 808, the electronic fitness data is processed to produce fitness information 102. In the exemplary embodiment, the server 116 receives the electronic fitness data in an XML format. Any of several protocols and techniques, however, can be used to transit the electronic fitness data to the server 116. Software code running on the server performs analysis, calculations, and other manipulation of the electronic fitness data to generate the fitness information 102. As explained above, the fitness information 102 may be a presentation of the raw fitness data 108 or may convey any of numerous correlations, calculations or other information based on the fitness data 108.

At step 810, the fitness information 102 is transmitted to the user terminal 810. The fitness information 102 is formatted in an appropriate protocol such as HTML and transmitted through the communication network 106. As discussed above, the communication network includes a packet switched network such as the Internet in the exemplary embodiment. The HTML message is deciphered by the web browser software running on the user terminal and displayed. Other protocols, techniques, and communication networks 106 may be used in some circumstances. For example, the fitness information 102 may be transmitted to the user terminal as an email or as an attachment to an email.

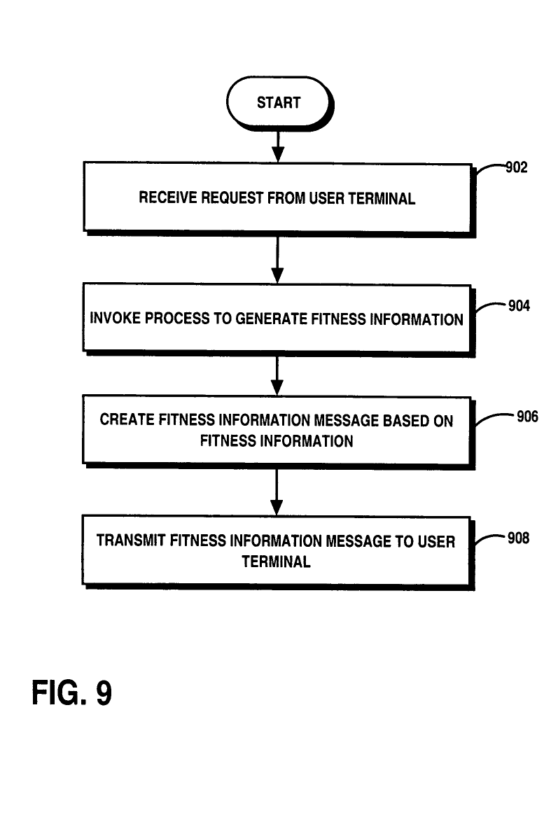

FIG. 9 is a flow chart of an exemplary method of processing electronic fitness data. Steps 902-906 of FIG. 9 provide a suitable example of a method of performing step 808 of FIG. 8 and step 908 provides an exemplary method of performing step 810.

At step 902, the server 112 receives a request from the user terminal 104. In the exemplary embodiment, the user submits a request by selecting a link, button or other interactive feature of the user interface 600. In accordance with known techniques an IP formatted message, such as an HTTP message, is transmitted through the Internet to the server 116. The request may be generated using other methods in come circumstances. The request may be transmitted using email for example.

At step 904, a process is invoked to generate fitness information 102 based on the fitness data 108. The process may be CGI (Common Gateway Interface) process, an API (Application Program Interface) process, a subroutine, a Java “servlet” or other program or software that provides a set of fitness information 102 based on the electronic fitness data representing the fitness data 108. Those skilled in the art will recognize the various techniques that can be used to perform the tasks of calculating and generating fitness information 102 from electronic fitness data based on the teachings herein as applied to known techniques.

At step 906, a fitness information 102 message is created based on the fitness information 102. The fitness information 102 message contains code or other information that can be deciphered by the user terminal 104 to display the fitness information 102. In the exemplary embodiment, an HTML message is created based on the fitness information 102. In some circumstances step 904 and 906 may be performed by a single process to return an HTML message in response to the user request.

At step 908, the fitness information message is transmitted to the user terminal. In the exemplary embodiment, the HTML message containing the fitness information 102 is transmitted through the communication network 106 to the user terminal 104.

Therefore, in the exemplary embodiment, the fitness participant (user) enters hand-marked fitness data 120 into a data record form to create a data record 110 containing fitness data 108. The data record 110 is then faxed or otherwise scanned and transmitted to the automated data collection engine 302 that converts the digital image of the data record 110 into the electronic fitness data. A technician verifies the electronic fitness data before it is forwarded to the server 116. The server 112 stores the electronic fitness data and generates fitness information 102 based on a user request received from the user terminal 104. The fitness information 102 is transmitted to the user terminal where it is displayed in accordance with known Internet techniques and protocols. The fitness participant may view the fitness information 102 identify trends, correlations, and other useful information that can be used to maximize the efficiency of fitness activities, diet, and other variables. Accordingly, the fitness participant utilizes the fitness data system 100 to easily and efficiently manage fitness data 108.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A method of managing fitness data, the method comprising:
converting hand-marked fitness data to electronic fitness data; and
displaying fitness information based on the electronic fitness data.

2. A method in accordance with claim 1, wherein the converting comprises:
scanning a fitness data record including the hand-marked fitness data to produce a digital image; and
processing the digital image to recognize characters of the hand-marked fitness data to produce the electronic fitness data.

3. A method in accordance with claim 2, further comprising:
transmitting the electronic fitness data through a communication network to a user terminal, wherein the displaying is through the user terminal.

4. A method in accordance with claim 3, wherein the processing comprises:
analyzing the hand-marked fitness data with an intelligent character recognition (ICR) process.

5. A method in accordance with claim 3, wherein the processing comprises:
analyzing the hand-marked fitness data with an optical mark recognition (OMR) process.

6. A method in accordance with claim 3, wherein the processing comprises:
analyzing the hand-marked fitness data with an optical character recognition (OCR) process.

7. A method in accordance with claim 3, wherein the hand-marked fitness data comprises handwritten characters expressing characteristics of a physical activity.

8. A method in accordance with claim 7, wherein the handwritten characters express a number of repetitions of the physical activity.

9. A method in accordance with claim 7, wherein the handwritten characters express a number of sets of the physical activity.

10. A method in accordance with claim 7, wherein the handwritten characters express a weight used during the physical activity.

11. A method in accordance with claim 7, wherein the handwritten characters express a physiological condition of a user during the physical activity.

12. A method in accordance with claim 7, wherein the handwritten characters express an environmental condition during the physical activity.

13. A method of managing fitness data, the method comprising:
scanning a fitness data record including the hand-marked fitness data to produce a digital image;
converting the hand-marked fitness data to electronic fitness data by processing the digital image to recognize represented values of the hand-marked fitness data;
transmitting the electronic fitness data through a packet switched network to a user terminal in response to a user request; and
displaying fitness information based on the electronic fitness data.

14. A method in accordance with claim 13, wherein the processing comprises:
analyzing the hand-marked fitness data with an intelligent character recognition (ICR) process.

15. A method in accordance with claim 13, wherein the processing comprises:
analyzing the hand-marked fitness data with an optical mark recognition (OMR) process.

16. A method in accordance with claim 13, wherein the processing comprises:
analyzing the hand-marked fitness data with an optical character recognition (OCR) process.

17. A system for managing fitness data, the system comprising:
a scanning device for scanning a data record comprising hand-marked fitness data;
a data processor for converting the hand-marked fitness data into electronic fitness data; and
a user terminal for displaying fitness information based on the electronic fitness data.

18. A system in accordance with claim 17, further comprising:
a server for generating the fitness information based on the hand-marked fitness data.

19. A system in accordance with claim 18, wherein the server is for transmitting a fitness information message based on the fitness information through a communication network to the user terminal.

20. A system in accordance with claim 19, wherein fitness information message is formatted in accordance with hypertext markup language techniques and the communication network includes an Internet.

21. A system in accordance with claim 19, wherein the data processor comprises an automated data collection engine for generating the electronic fitness data based on a recognition of hand-marked fitness data values of the hand-marked fitness data.

22. A system in accordance with claim 21, further comprising:
a data verification engine for verifying an accuracy of the electronic fitness data.

23. A system in accordance with claim 21, wherein the hand-marked fitness data comprises handwritten characters expressing characteristics of a physical activity.

24. A system in accordance with claim 23, wherein the handwritten characters express a number of repetitions of the physical activity.

25. A system in accordance with claim 23, wherein the handwritten characters express a number of sets of the physical activity.

26. A system in accordance with claim 23, wherein the handwritten characters express a weight used during the physical activity.

27. A system in accordance with claim 23, wherein the handwritten characters express a physiological condition of a user during the physical activity.

28. A system in accordance with claim 23, wherein the handwritten characters express an environmental condition during the physical activity.

29. A system in accordance with claim 21, wherein the fitness information comprises graphical information conveying a relationship between two or more fitness data values.

30. A system in accordance with claim 17, wherein the fitness information comprises a table conveying a relationship between two or more fitness data values.

31. A system in accordance with claim 17, wherein the fitness information comprises written text conveying a relationship between two or more fitness data values.

32. A server for managing fitness data, the server configured to generate fitness information from electronic fitness information derived from a digital image of a data record comprising hand-marked fitness data.

33. A server in accordance with claim 32, the server further configured to transmit a fitness information message based on the fitness information through a communication network.

34. A server in accordance with claim 33, wherein the fitness information message is a hypertext markup language (HTML) message.

35. A server in accordance with claim 33, wherein the hand-marked fitness data comprises handwritten characters expressing characteristics of a physical activity.

36. A server in accordance with claim 35, wherein the handwritten characters express a number of repetitions of the physical activity.

37. A server in accordance with claim 35, wherein the handwritten characters express a number of sets of the physical activity.

38. A server in accordance with claim 35, wherein the handwritten characters express a weight used during the physical activity.

39. A server in accordance with claim 35, wherein the handwritten characters express a physiological condition of a user during the physical activity.

40. A server in accordance with claim 35, wherein the handwritten characters express an environmental condition during the physical activity.

41. A server in accordance with claim 33, wherein the fitness information comprises graphical information conveying a relationship between two or more fitness data values.

42. A server in accordance with claim 33, wherein the fitness information comprises a table conveying a relationship between two or more fitness data values.

43. A server in accordance with claim 33, wherein the fitness information comprises written text conveying a relationship between two or more fitness data values.
